(19) United States
(12) Patent Application Publication
(10) Pub. No.: US 2001/0043797 A1
(43) Pub. Date: Nov. 22, 2001

(54) Digital videodisc player

(76) Inventor: Tadashi Tachibana, Osaka (JP)

Correspondence Address: Jonathan P. Osha, ROSENTHAL & OSHA L.L.P., Suite 4550, 700 Louisiana, Houston, TX, 77002, US

(21) Appl. No.: 09/855,135

(22) Filed: May 14, 2001

(30) Foreign Application Priority Data
May 16, 2000 (JP) P. 2000-143336

(51) Int. Cl. H04N 5/783; H04N 5/781

(52) U.S. Cl. 386/70; 386/126

(57) ABSTRACT

When a recording medium is mounted in a DVD player, the kind of the recording medium is presumed by detecting the number of recording surfaces and a reflection factor from the output of an optical pick-up, a parameter of a servo control means is set to a parameter of the presumed kind of recording medium (S11) and reading from the recording medium is tried (S12). As a result, in case that the data is readable, the kind of the recording medium is specified (S13). On the other hand, in case that the data is not readable, the parameter of the servo control means is sequentially set to parameters of other kinds of recording mediums (S14, 17), and reading is tried for each setting (S15, 18), whereby the kind of the recording medium is specified (S16, 19).

### BACKGROUND OF THE INVENTION

[Technical Field of the Invention]

The present invention relates to a digital videodisc player and particularly to a digital videodisc player that can read data from the predetermined plural kinds of recording mediums.

[Related Art]

In an audio player that can data from the plural kinds of recording mediums such as a DVD (digital videodisc), a CD (compact disc) and the like, it is necessary to previously specify the kind of recording medium before reproducing or recording of the recording medium. Heretofore, as a method of judging the kind of recording medium, there is a method disclosed in, for example, the Unexamined Japanese Patent Application Publication No. Hei11-191264.

According to the above-disclosed judgment method, the kind of recording medium is specified on the basis of the number of peaks and a peak value of a focus error signal. Firstly, the recording medium is irradiated with leaser beams while the focus position of the leaser beam is being changed, and then the reflected light from the recording medium is detected by an optical sensor. The optical sensor has a light receiving part comprising four light receiving regions, and converts the reflected light received by each region into an electrical signal. The electrical signals at the diagonal regions are added to each other, and the difference between the electrical signals after addition is calculated, whereby a focus error signal is obtained. This focus error signal has the number of S-shaped peaks according to the number of the recording surfaces, and has a peak value according to the kind of the recording medium. Accordingly, on the basis of the number of peaks and the peak value of the focus error signal, the kind of recording medium is specified.

[Problem that the Invention is to Solve]

In the above-disclosed method, the focus error signal is generated at the unexpected position by an individual difference of recording medium, or the peak values of the focus error signals vary, whereby there is the occasion that the judgment of the kind of the recording medium is mistaken. This processing method is not described in the above official gazette. In case that the judgment of the kind is mistaken and the recording medium is not read, it is generally thought to calculate the focus error signal again to judge the kind. However, the result of the reprocessing is frequently the same as the previous result, and the reading error is repeated each time, so that there is a problem that the recording medium cannot be specified even if a long time passes.

### SUMMARY OF THE INVENTION

An object of the invention is to make it possible to judge the kind of recording medium exactly and quickly in a digital videodisc player.

[Means for Solving the Problem]

A digital videodisc player (DVD player) according to the first aspect of the invention is a DVD player that can read data from the predetermined plural kinds of recording mediums, and comprises an optical pick-up, a signal processing means, a servo control means, and a judgment means. The optical pick-up irradiates the recording medium with laser beams and detects the reflected light to convert it into an electric signal. The signal processing means applies the predetermined processing to the electric signal and converts the electric signal into a video and/or audio signal. The servo control means controls the positional relation between the recording medium and the optical pick-up according to the kind of recording medium. The judgment means, when the recording medium is mounted, detects the number of recording surfaces and a reflection factor from the output of the optical pick-up to presume the kind of the recording medium, and sets a parameter of the servo control means to a parameter of the above presumed kind of recording medium thereby to try reading from the recording medium. In result, in case that the data is readable, the kind of the recording medium is specified. On the other hand, in case that the data is not readable, a parameter of the servo control means is set to parameters of other kinds of recording mediums in sequence, and reading for each setting is tried thereby to specify the kind of the recording medium.

In this DVD player, on the basis of the number of recording surfaces and the reflection factor, the kind of recording medium is presumed and reading is tried. And, in case that the data is readable, the kind of the recording medium is specified, while in case that the data is not readable, the kind of recording medium is successively presumed other kinds to try reading.

According to such the DVD player, since the kind of recording medium is successively presumed other kinds to try reading, it is possible to prevent that the kind is presumed the previous erroneous kind and the kind of recording medium cannot be specified. Further, since the kind is successively specified and reading is tried, the kinds of recording mediums representing the same optical characteristic, such as DVD−RW and DVD+RW can also specified.

According to the second aspect of the invention, in the player of the first aspect of the invention, the predetermined plural kinds of recording mediums are any of a digital videodisc having a single-layered recording surface (single layer DVD), a digital videodisc having a two-layered recording surface (two layer DVD), and a compact disc (CD).

In this case, it is possible to judge quickly which of the single layer DVD, the two layer DVD, and the CD that are used best at present the recording medium is.

### BRIEF DESCRIPTION OF THE DRAWINGS

FIG. 1 is a diagram showing a DVD player to which one embodiment of the invention is applied.

FIG. 2 is a diagram for explaining the principle of measurement of a focus error signal.

FIGS. 3A to 3C are schematic diagrams of waveforms of the focus error signal.

FIG. 4 is a diagram showing judgment control of the kind of recording medium.

FIG. 5 is a diagram showing a first judgment control.

FIG. 6 is a diagram showing a second judgment control.

FIG. 7 is a diagram showing a third judgment control.

### DETAILED DESCRIPTION OF THE PREFERRED EMBODIMENTS

[Mode for Carrying Out the Invention]

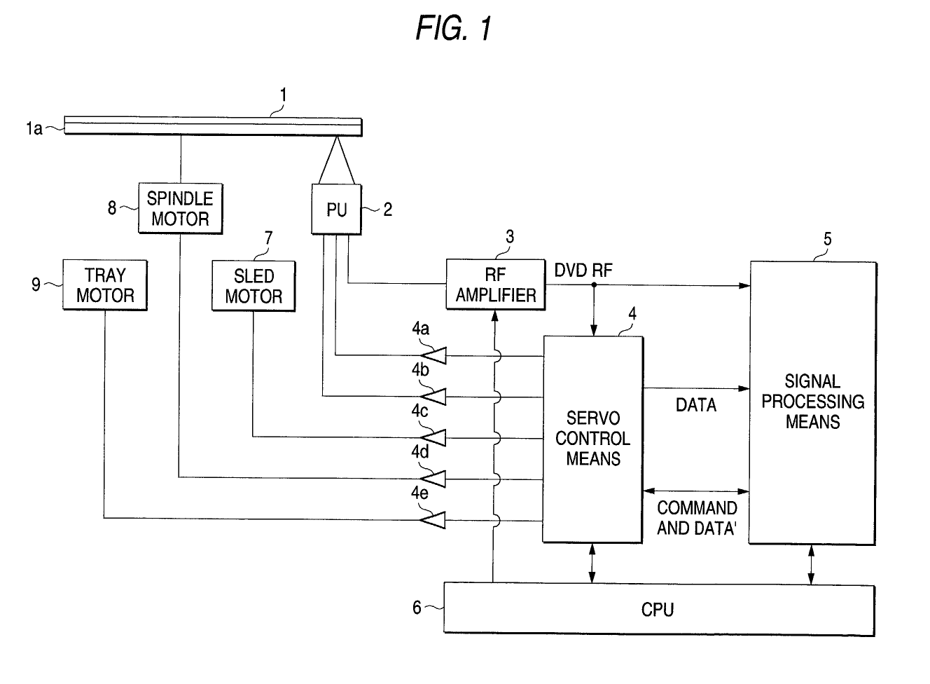

FIG. 1 shows a schematic constitutional diagram of a DVD player to which one embodiment of the invention is applied. This DVD player is mainly composed of an optical pick-up 2 (PU in the figure), a servo control means 4, a signal processing means 5, and a CPU 6.

The optical pick-up 2 includes a semiconductor laser for irradiating beams having a predetermined wavelength, an objective for concentrating the laser beams on a recording surface 1a of a recording medium 1, and an optical sensor for detecting the reflected light and converting it into an electrical signal (they are not shown). A RF Amp 3 is connected to the optical pick-up 2, and amplifies the electrical signal from the optical sensor to output it to the servo control means 4 and the signal processing means 5. The servo control means 4 is connected to amplifiers 4a to 4e, and outputs drive signals through the amplifiers 4a to 4e to the optical pick-up 2, a sled motor 7, a spindle motor 8 and a tray motor 9 on the basis of instructions from the CPU 6. The servo control means 4 supplies the drive signal through the amplifier 4a to the optical pick-up 2, and causes the semiconductor laser to irradiate the beams. Further, the servo control means 4 supplies the drive signal through the amplifier 4b to the optical pick-up 2, and controls the distance between the objective and the recording medium 1. Further, the servo control means 4 supplies the drive signal through the amplifier 4c to the sled motor 7, and drives the sled motor 7 thereby to move the optical pick-up 2 in the radial direction of the recording medium 1. Further, the servo control means 4 supplies the drive signal through the amplifier 4d to the spindle motor 8, and drives the spindle motor 8 thereby to turn the recording medium 1. Further, the servo control means 4 supplies the drive signal through the amplifier 4f to the tray motor 9, and drives the tray motor 9 thereby to take the tray on which the recording medium 1 is mounted in and out. The CPU 6 is an operational circuit for controlling the RF Amp 3, the servo control means 4 and the signal processing means 5. The signal processing means 5 applies the predetermined processing to the detection signal output by the RF Amp 3 thereby to output a video signal and/or audio signal.

In the thus constructed DVD player, audio and video are reproduced by the following process. The DVD player judges the kind of the recording medium placed at the predetermined position by the tray motor 9 1 by judge control which will be described later, and sets a parameter according to the kind to the servo control means 4. The set parameter includes the distance between the objective and the recording medium, turn speed of the sled motor 7 and spindle motor 8, and the like. After setting, the servo control means 4 drives the optical pick-up 2, the sled motor 7 and the spindle motor 8, regulates the positions of the recording surface 1a and the optical pick-up 2, and concentrates the laser beams on the recording surface 1a. The optical sensor detects the reflected light from the recording medium 1a and converts it into the electrical signal, and the detection signal amplified by the RF Amp 3 is input to the servo control means 4 and the signal processing means 5. The detection signal is subjected to the predetermined processing by the signal processing means 5, converted into the video signal and/or audio signal, and then output to a television, a speaker or the like. Further, the detection signal input to the servo control means 4 performs feedback control of the optical pick-up 2, the sled motor 7 and the spindle motor 8.

[Principle of Judgment]

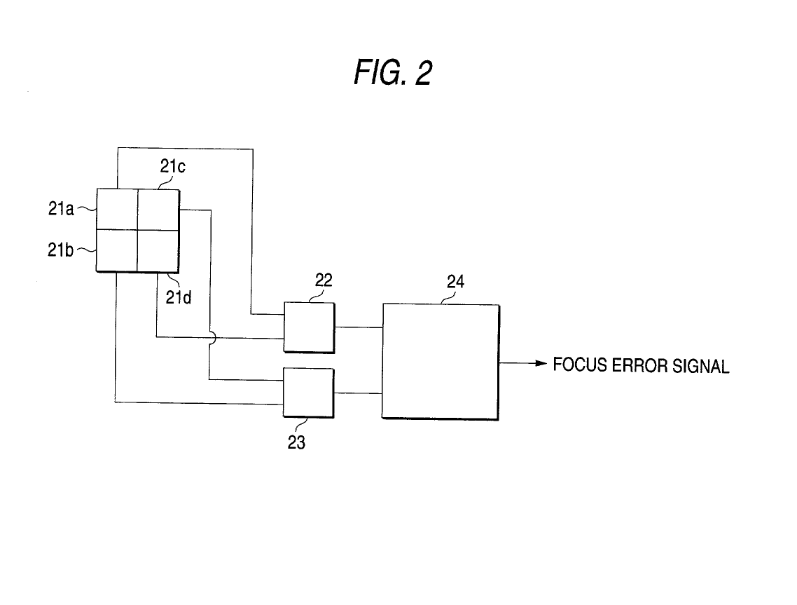

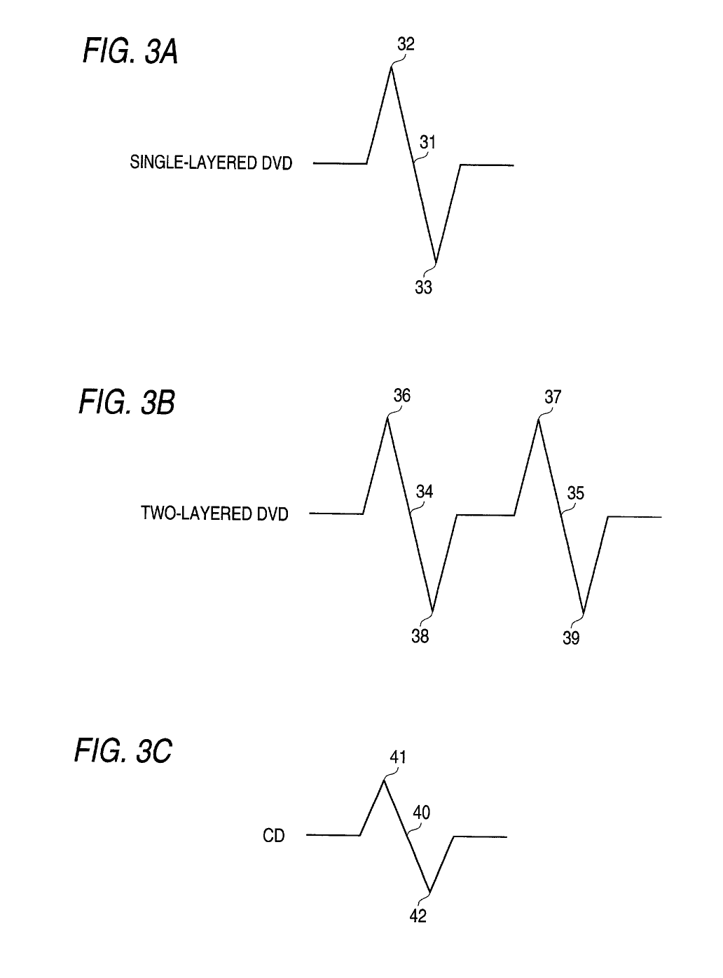

Next, the principle of judgment for specifying the kind of the recording medium 1 will be described. FIG. 2 is a diagram for explaining the principle of measurement of the focus error signal used to judge the kind of the recording medium 1. FIG. 3 is a diagram showing examples of measurement of the focus error signals on the respective recording mediums.

In FIG. 2, reference numerals 21a to 21d are optical sensors, reference numerals 22 and 23 are adders, and reference numeral 24 is a subtracter. The measurement of the focus error signal is performed by measuring the reflected light while the objective of the optical pick-up 2 is being approached to the recording medium 1. While the objective of the optical pick-up 2 is being approached to the recording medium 1 by supplying the drive signal from the servo control means 4 through the amplifier 4b to the optical pick-up 2, the recording medium 1 is irradiated with the laser beams, and the reflected light is detected by the optical sensor. The optical sensors 21a to 21d detect the strength of the reflected light detected at each region and convert it into the electrical signal. The electrical signals by the optical sensors 21a and 21c are added to each other by the adder 22, and the electrical signals by the optical sensors 21b and 21d are added to each other by the adder 23. And, the outputs from the adders 22 and 23 are input to the subtracter 24. The difference between them is calculated as a focus error signal. The optical sensors 21a to 21d are arranged about a laser optical axis at the predetermined angle degrees. Hereby, when the focus of the laser beam does not coincide with the recording surface, the strengths of the electrical signals output by the respective optical sensors vary and the strength of the focus error signal does not become zero. On the other hand, when the focus of the laser beam coincides with the recording surface, the strengths of the electrical signals output by the respective optical sensors are the same and the strength of the focus error signal becomes zero.

The thus measured focus error signal, before and after the focus of the objective is located on the recording surface of the recording medium, indicates a S-shaped peak waveform. The number of the peak waveforms and the amplitude of vibration of the peak waveform are different according to the kind of recording medium. FIGS. 3A to 3C are schematic diagrams showing the change of the S-shaped peak waveform in each recording medium. For example, the focus error signal of the DVD having the single-layered recording surface (hereinafter referred to as a single-layered DVD) changes as shown in FIG. 3A. As the objective approaches the recording surface 1a, the focus error signal increases thereby to produce a peak 32. When the objective further approaches the recording surface 1a and the focus of the objective coincides with the recording surface 1a, the value of the focus error signal becomes zero at a coincident point 31. As the objective is further approached, a peak 33 of the opposite polarity is produced. In case of the DVD having the two-layered recording surface (hereinafter referred to as a two-layered DVD), as shown in FIG. 3B, peaks 36, 38 and 37, 39 are produced in relation to the recording surfaces, and coincident points 34, 35 are produced in relation to the recording surfaces. In case of the CD, since the recording surface has a single layer, a set of peaks 41, 42 and a coincident point 40 are produced as shown in FIG. 3C. However, the strength of the peak 41, 42 is smaller than the strength of the peak 32, 33 of the single layered DVD.

Accordingly, from the number of the S-shaped peaks of the focus error signal and its peak strength, the recording medium can be presumed.

In the following description, the number of peaks is judged with taking a set of up and down peaks (for example, 32 and 33) as one S-shaped peak.

[Judgment Control]

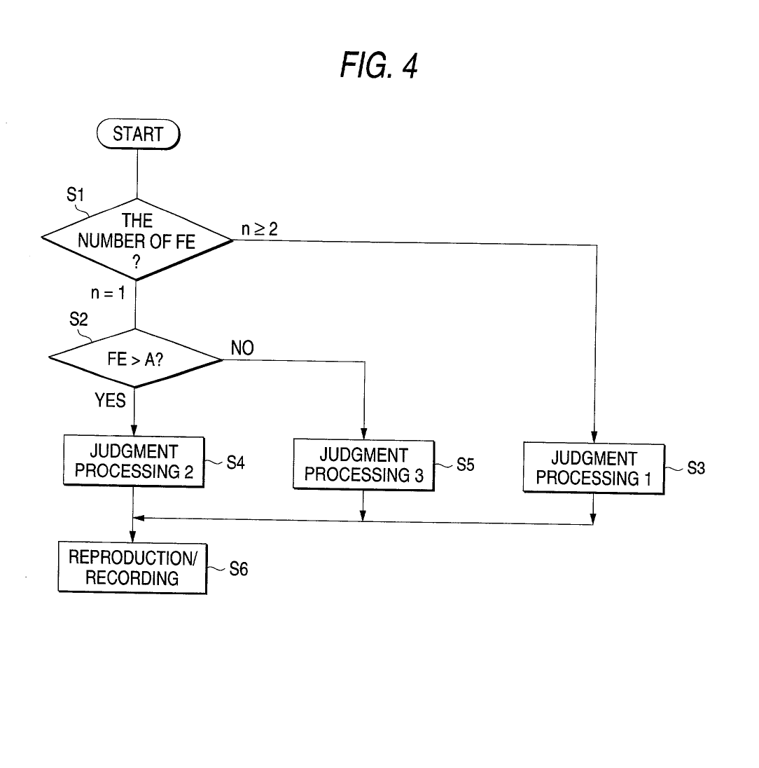

Examples of control for judging the kind of the recording medium 1 will be described below with reference to flowcharts of FIGS. 4 to 7. Here, an example in case of a DVD player that reproduces/records a single-layered DVD, a two-layered DVD and a CD is shown.

In a step S1, the DVD player, when the recording medium 1 is inserted in it, judges the number of peaks of the aforesaid focus error signal. In case that the number of peaks is two and more, the player proceeds to a step S3 and executes a judgment processing 1 which will be described layer. In case that the number of peaks is one, the player proceeds to a step S2.

In the step S2, whether the strength of peak of the focus error signal is larger or not than the predetermined value A is judged. In case that the strength of peak is larger than the predetermined value A, the player proceeds to a step S4 and executes a judgment processing 2 which will be described layer. In case that the strength of peak is below the predetermined value A, the player proceeds to a step S5 and executes a judgment processing 3 which will be described layer.

In step S6, after the DVD player executed the judgment processing 1, 2 or 3, it reads data from the recording medium 1 and reproduces/records the video signal and/or audio signal.

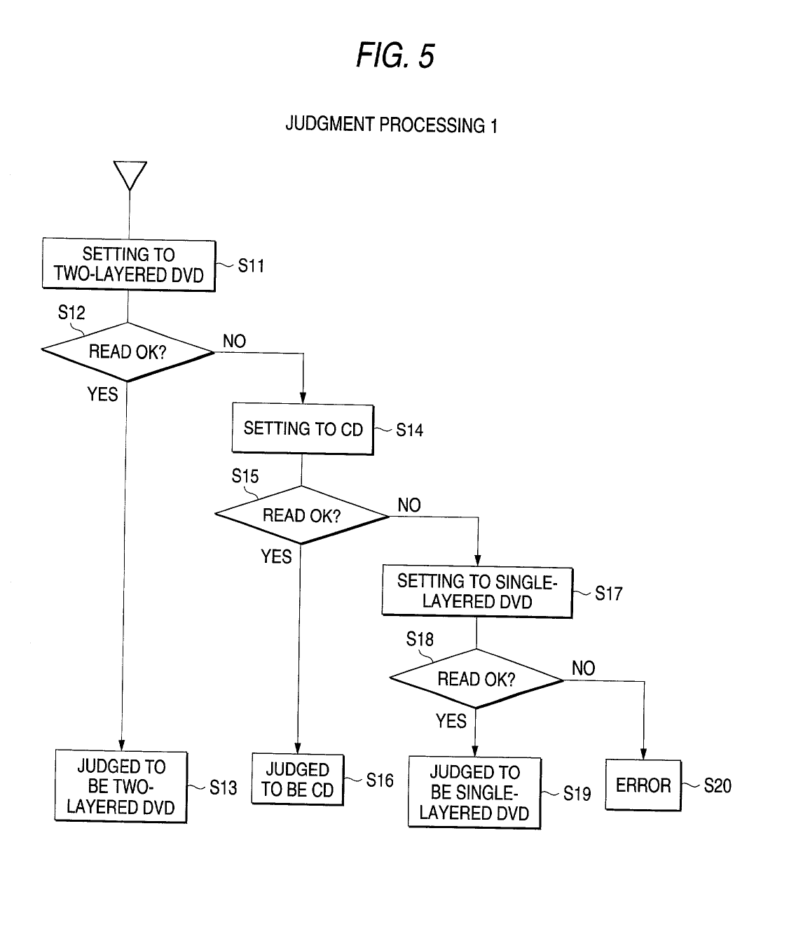

Firstly, the judgment processing 1 will be described with reference to FIG. 5.

In step 11, the DVD player sets a parameter of two-layered DVD in the servo control means 4, and proceeds to a step S12. In the step S12, the player drives the servo control means 4 by the parameter of two-layered DVD to try reading of data from the recording medium 1. In case that the data is readable, the player proceeds to a step 513 from the step S12 and determines that the kind of the recording medium 1 is a two-layered DVD. Thereafter, the player performs the usual reproduction/recording. In case that the data is not readable in the step S12, the player proceeds to a step S14.

In the step S14, the player sets a parameter of CD in the servo control means 4 and proceeds to a step S15. In the step S15, the player drives the servo control means 4 by the parameter of CD to try reading of data from the recording medium 1. In case that the data is readable, the player proceeds to the step S16 from the step S15 and determines that the kind of the recording medium 1 is a CD. Thereafter, the player performs the usual reproduction/recording. In case that the data is not readable in the step S15, the player proceeds to a step S17.

In the step S17, the player sets a parameter of single-layered DVD in the servo control means 4 and proceeds to a step S18. In the step S18, the player drives the servo control means 4 by the parameter of single-layered DVD to try reading of data from the recording medium 1. In case that the data is readable, the player proceeds to a step S19 from the step S18 and determines that the kind of the recording medium 1 is a single-layered DVD. Thereafter, the player performs the usual reproduction/recording. In case that the data is not readable in the step S18, the player proceeds to a step S20. In the step S20, the player performs the predetermined error processing. For example, the player displays an error signal representing that the data cannot be read from the recording medium 1 in a display means.

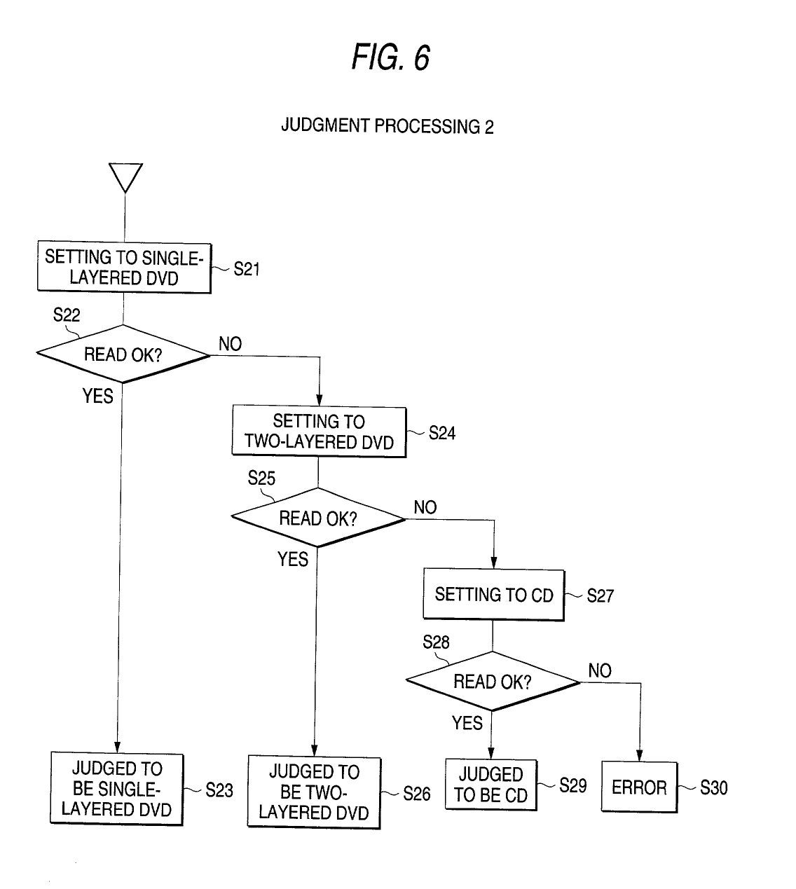

Next, the judgment processing 2 will be described with reference to FIG. 6.

In a step 21, the DVD player sets a parameter of single-layered DVD in the servo control means 4 and proceeds to a step S22. In the step S22, the player drives the servo control means 4 by the parameter of single layered DVD to try reading of data from the recording medium 1. In case that the data is readable, the player proceeds to a step S23 from the step S22 and determines that the kind of the recording medium 1 is a single-layered DVD. Thereafter, the player performs the usual reproduction/recording. In case that the data is not readable in the step S22, the player proceeds to a step S24.

In the step 24, the DVD player sets a parameter of two-layered DVD in the servo control means 4, and proceeds to a step S25. In the step S25, the player drives the servo control means 4 by the parameter of two-layered DVD to try reading of data from the recording medium 1. In case that the data is readable, the player proceeds to a step S26 from the step S25 and determines that the kind of the recording medium 1 is a two-layered DVD. Thereafter, the player performs the usual reproduction/recording. In case that the data is not readable in the step S25, the player proceeds to a step S27.

In the step S27, the player sets a parameter of CD in the servo control means 4 and proceeds to a step S28. In the step S28, the player drives the servo control means 4 by the parameter of CD to try reading of data from the recording medium 1. In case that the data is readable, the player proceeds to a step S29 from the step S28 and determines that the kind of the recording medium 1 is a CD. In case that the data is not readable in the step S28, the player proceeds to a step S30. In the step S30, the player performs the predetermined error processing. For example, the player displays an error signal representing that the data cannot be read from the recording medium 1 in a display means.

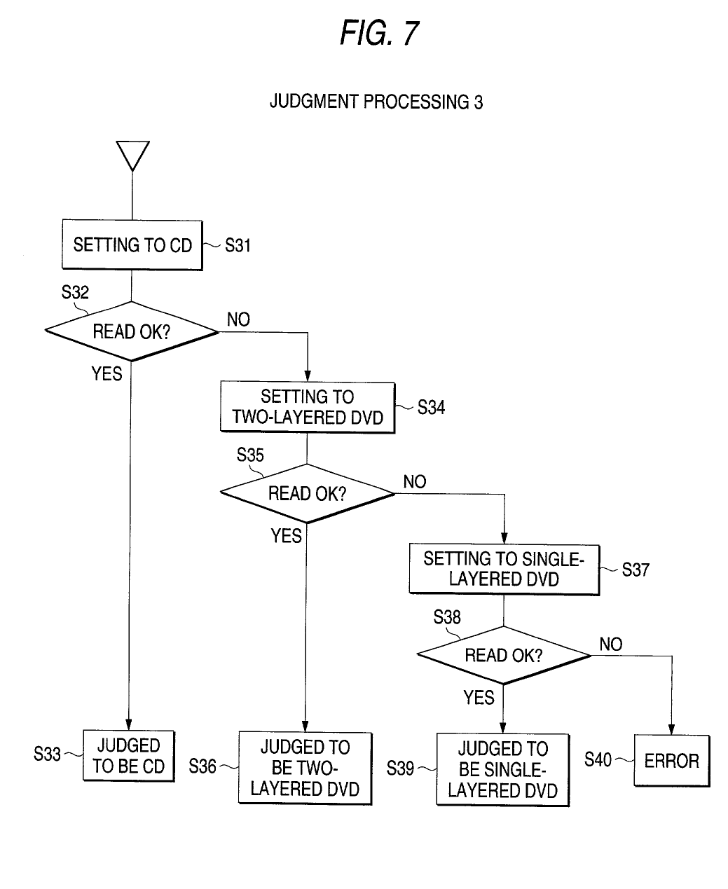

Next, the judgment processing 2 will be described with reference to FIG. 7.

In a step 31, the DVD player sets a parameter of CD in the servo control means 4 and proceeds to a step S32. In the step S32, the player drives the servo control means 4 by the parameter of CD to try reading of data from the recording medium 1. In case that the data is readable, the player proceeds to a step S33 from the step S32 and determines that the kind of the recording medium 1 is a CD. Thereafter, the player performs the usual reproduction/recording. In case that the data is not readable in the step S32, the player proceeds to a step S34.

In the step 34, the DVD player sets a parameter of two-layered DVD in the servo control means 4, and proceeds to a step S35. In the step S35, the player drives the servo control means 4 by the parameter of two-layered DVD to try reading of data from the recording medium 1. In case that the data is readable, the player proceeds to a step S36 from the step S35 and determines that the kind of the recording medium 1 is a two-layered DVD. Thereafter, the player performs the usual reproduction/recording. In case that the data is not readable in the step S35, the player proceeds to a step S37.

In the step 37, the player sets a parameter of single-layered DVD in the servo control means 4 and proceeds to a step S38. In the step S38, the player drives the servo control means 4 by the parameter of single-layered DVD to try reading of data from the recording medium 1. In case that the data is readable, the player proceeds to a step S39 from the step S38 and determines that the kind of the recording medium 1 is a single-layered DVD. Thereafter, the player performs the usual reproduction/recording. In case that the data is not readable in the step S38, the player proceeds to a step S40. In the step S40, the player performs the predetermined error processing. For example, the player displays an error signal representing that the data cannot be read from the recording medium 1 in a display means.

[Other Embodiments]

(A) In the above embodiment, an example of the order of presuming the recording medium is described. However, the order is not limited to this. For example, depending on the design of optical pick-up, to presume the recording medium in the different order from the order in the above embodiment makes a quick judgment of the kind possible.

(B) In the above embodiment, the case in which the data are read from the single-layered DVD, the two-layered DVD and the CD is described. However, the invention can be applied also to a case in which another kind of recording medium than these kinds is specified. Particularly, in case of many kinds, by preventing repeat of the judgment mistake, the quick judgment can be performed. Further, since the kind is specified successively and reading is tried, it is also possible to specify the kinds of recording mediums representing the same optical characteristics, such as DVD-RW and DVD+RW.

[Effect of the Invention]

According to the judging means of the invention, in the DVD player for reading data from the predetermined plural kinds of recording mediums, recording medium is successively presumed the predetermined kinds and reading is tried. Therefore, it is possible to prevent the same judgment mistake from being repeated. Hereby, the kind of the recording medium can be judged exactly and quickly.

What is claimed is:

1. A digital videodisc player that reads data from predetermined plural kinds of recording mediums comprising:
an optical pick-up that irradiates the recording medium with laser beams and detects the reflected light to convert thereof into an electric signal;
signal processing means that applies the predetermined processing to the electric signal and converts the electric signal into a video and/or audio signal;
servo control means that controls the positional relation between the recording medium and said optical pick-up according to the kind of the recording medium; and
judgment means that specifies the kind of the recording medium by, when the recording medium is mounted, detecting the number of recording surfaces and a reflection factor from the output of said optical pick-up to presume the kind of the recording medium, setting a parameter of said servo control means to a parameter of the presumed kind of recording medium to try reading from the recording medium, specifying the kind of the recording medium in case that the data is readable, and setting a parameter of said servo control means in sequence to parameters of other kinds of recording mediums to try reading for each setting in case that the data is not readable.

2. The digital video disc player according to claim 1, wherein
the predetermined plural kinds of recording mediums are selected from a group of a digital videodisc having a single-layered recording surface, a digital videodisc having a two-layered recording surface, and a compact disc.

3. A digital videodisc player that reads data from predetermined plural kinds of recording mediums comprising:
an optical pick-up that irradiates the recording medium with laser beams and detects the reflected light to convert thereof into an electric signal;
a signal processor that applies the predetermined processing to the electric signal and converts the electric signal into a video and/or audio signal;
a servo controller that controls the positional relation between the recording medium and said optical pick-up according to the kind of the recording medium; and
a judgment section that specifies the kind of the recording medium by, when the recording medium is mounted, detecting the number of recording surfaces and a reflection factor from the output of said optical pick-up to presume the kind of the recording medium, setting a parameter of said servo controller to a parameter of the presumed kind of recording medium to try reading from the recording medium, specifying the kind of the recording medium in case that the data is readable, and setting a parameter of said servo controller in sequence to parameters of other kinds of recording mediums to try reading for each setting in case that the data is not readable.

4. The digital video disc player according to claim 3, wherein
the predetermined plural kinds of recording mediums are selected from a group of a digital videodisc having a single-layered recording surface, a digital videodisc having a two-layered recording surface, and a compact disc.
